(19) United States
(12) Patent Application Publication
(10) Pub. No.: US 2014/0172705 A1
(43) Pub. Date: Jun. 19, 2014

(54) SYSTEMS AND METHODS FOR EXTENDING SIGNATURE TECHNOLOGY

(71) Applicant: SAS Institute Inc., Cary, NC (US)

(72) Inventors: Brian Duke, San Diego, CA (US); Paul Dulany, San Diego, CA (US); HoMing Luk, San Diego, CA (US)

(73) Assignee: SAS Institute Inc., Cary, NC (US)

(21) Appl. No.: 13/717,610

(22) Filed: Dec. 17, 2012

(51) Int. Cl. G06Q 20/40

(52) U.S. Cl. CPC G06Q 20/4016
USPC 705/44

(57) ABSTRACT

Systems and methods extending signatures are provided. Some of the disclosed systems and methods can include receiving, on a computing device, transaction data associated with one or more entities, wherein the transaction data is associated with one or more keys; determining one or more keys associated with the one or more entities, wherein each entity has corresponding signature data, and wherein signature data includes one or more associated keys; matching the one or more keys associated with the transaction data to one or more keys associated with the signature data corresponding to the one or more entities; and retrieving the signature data corresponding to the one or more entities. The systems and methods may further comprise updating the signature data with the transaction data; using a scoring engine to score the updated signature data; and storing the updated signature data.

### TECHNICAL FIELD

The present disclosure relates generally to computer-implemented systems and methods for extending signature technology.

### BACKGROUND

In some systems, signatures may maintain behavioral data based upon transactions. For example, signatures may allow the storage of detailed transaction data for entities such as credit or debit cards, accounts, customers, online banking user-ids, merchants or any other entity of interest.

### SUMMARY

Systems and methods extending signatures are provided. Some of the disclosed systems and methods can include receiving, on a computing device, transaction data associated with one or more entities, wherein the transaction data is associated with one or more keys; determining one or more keys associated with the one or more entities, wherein each entity has corresponding signature data, and wherein signature data includes one or more associated keys; matching the one or more keys associated with the transaction data to one or more keys associated with the signature data corresponding to the one or more entities; and retrieving the signature data corresponding to the one or more entities. The systems and methods may further comprise updating the signature data with the transaction data; using a scoring engine to score the updated signature data; and storing the updated signature data.

In some implementations, the systems and methods can comprise determining that two or more entities correspond to a same type of entity and are associated with a same transaction, generating signature linking data using the keys associated with the two or more entities, retrieving the signature data corresponding to the two or more entities, using the linking data, and using the scoring engine to score the updated signature data and the signature linking data, wherein the score utilizes the linking relationship between the two or more entities.

In some implementations, determining one or more key identifiers can include using fields that identify a type of entity and a type of data associated with an entity. In some implementations, a scoring engine can be used to dynamically determine one or more keys associated with the transaction data. In other implementations, a scoring engine can be used to dynamically determine whether one or more entities are associated with the transaction data.

In some implementations, signature data can include historical data associated with an entity. In some implementations, a score can indicate a likelihood of one or more factors including a likelihood of fraud, a likelihood of credit risk, a likelihood of attrition, or a likelihood of commercial interest.

In some implementations, an entity can be associated with a type. In these implementations, account data can be associated with an entity when the entity type is personal, and card data can be associated with an entity when the entity type is business.

In some implementation, signatures corresponding to one or more entities include simple signatures, complex signatures, and linked signatures.

In some implementations, matching can include using a scoring engine to dynamically determine one or more keys associated with the one or more entities.

The details of one or more embodiments of the invention are set forth in the accompanying drawings and the description below. Other features and aspects, will become apparent from the description, the drawings, and the claims.

### BRIEF DESCRIPTION OF THE DRAWINGS

The utility of the embodiments will be readily appreciated and understood from consideration of the following description of the embodiments when viewed in connection with the accompanying drawings, wherein:

FIG. 1 shows a block diagram of an example system 100 for extending signature technology;

FIG. 2 is a flow chart illustrating an example of a process for accepting a transaction request from a device;

FIGS. 3A and 3B are timing diagrams illustrating an example of the process of a transaction in an example system using conventional signatures;

FIG. 4A is a timing diagram illustrating an example of processing of a transfer from a payer account to a payee account utilizing symbolically linked signatures;

FIG. 4B is a flowchart illustrating an example of processing of a transfer from a payer account to a payee account utilizing symbolically linked signatures;

FIG. 5 is a timing diagram illustrating an example of the processing of two transfers from payer accounts to a payee account utilizing symbolically-linked signatures; and

FIG. 6 is a timing diagram illustrating an example of a process for utilizing complex keyed signatures.

Like reference numbers and designations in the various drawings indicate like elements.

### DETAILED DESCRIPTION

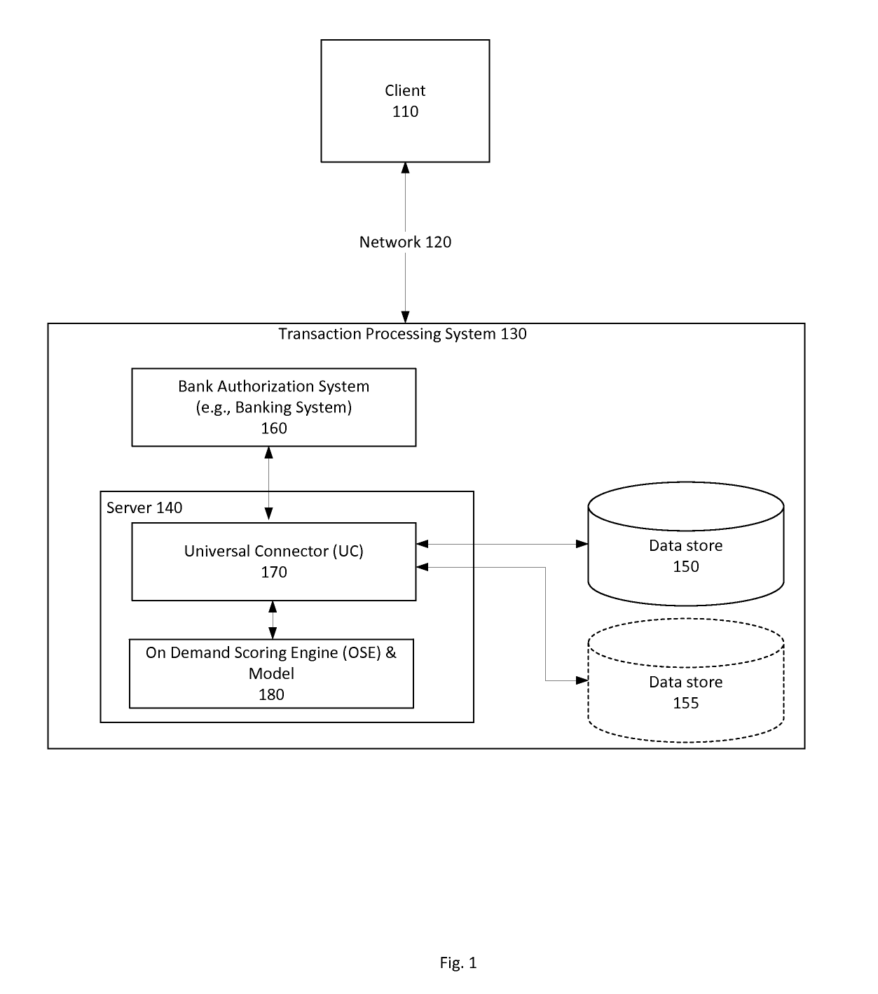

FIG. 1 shows a block diagram of an example system 100 for extending signature technology. System 100 can be a computer-implemented environment wherein one or more users interact with a point-of-sale terminal, ATM, or other device, referred to herein as a client 110. The client 110 shown includes software executing on a processor and one or more communications interfaces that enable the software on client 110 to communicate over a network 120 with a transaction processing system 130. The transaction processing system 130 includes an account management system, e.g., a bank system 160. In some implementations the account management system is referred to as an authorization system. The account management system 160 processes transactions, such as banking transactions and communicates with server 140. In some embodiments, the account management system 160 or banking system is itself considered the client 110, and the client 110 is referred to as a terminal.

The transaction processing system 130 includes one or more servers, such as server 140. While a single server 140 is shown, some embodiments may include multiple servers. The servers may be virtual or physical servers and may be located in geographically disparate locations. The server 140 includes software that implements operations or routines for extending signature technology. The software includes software for receiving transactions from various sources, such as client 110 and/or any devices that alone or collectively allows customers to enter transactions. The software also includes software for analyzing the transactions to determine whether fraud may have occurred in relation to the accounts associated with the transactions.

In the embodiment shown, the server 140 is in communication with a data store 150. Examples of data store(s) 150 can include relational database management systems (RDBMS), a multi-dimensional database (MDDB), such as an Online Analytical Processing (OLAP) database, or an in-memory database (IMDB). The description of the example system 100 shown in FIG. 1 is merely illustrative, and the Figures below are described in relation to system 100 merely for clarity. The data store 150 may store data in a raw form. For example, the data store 150 may store all of the raw data for the last 15-20 transactions for a particular account to enable processing according to embodiments of the present invention.

The server 140 includes various software components, including a universal connector (UC) 170 in communication with the account management system. In the embodiment shown, the account management system 160 and UC 170 are shown to be on the same server. However, in some embodiments, the account management system 160 and UC 170 are present on separate servers and may be present in separate geographic locations. They also each may access a different data store 150. The UC 170 acts as an interface that connects various other components of an embodiment of the present invention with account management system 160 and other processing systems that may be present on the server 140 or on other servers. In the embodiment shown, transactions, such as payments from an account flow from the account management system 160 to the UC 170, where they are prepared by appending the appropriate data based on the transaction type. Data may contain information, such as user and system variables and will vary depending on transaction type.

The embodiment in FIG. 1 also includes an On-Demand Scoring Engine & Model (OSE) 180. The OSE 180 is in communication with the UC 170, and together, they control the use of models and the execution of both user-written and system rules. The UC 170 submits the transaction to the scoring engine 180, which then executes the appropriate models to automatically and dynamically produce a score, as well as executing the associated decision logic or rules as specified by the developer of the system.

The OSE 180 allows the use of signature entities (e.g., account, customer, IP, etc.). A signature record may be retrieved from the data store 160 by deriving features from the raw data. In some embodiments, raw data is stored in the signature. Then the signature fields can be used to create model variables that are summaries of the data stored in the signature. These model variables can be used as the final inputs into the model and scoring. The raw data itself may not be used for scoring. For example, a signature may be an account-level compilation of historic data of some or all transaction types. In one embodiment, the signature includes information regarding the previous thirty transactions for an account, including amounts and times. The signature may also include information, such as whether the user swiped a card or used another method of entering the account information. Further, the signature may include a location, such as a postal code or latitude and longitude for a transaction. Signatures help a model to recognize behavior change (e.g., to detect a trend and deviation from a trend). In one embodiment, one record is stored for each account. Signature data may be updated with every new transaction.

Such embodiments can utilize raw data to monitor each transaction, allowing the system to capture customer behavior patterns from a variety of sources and evaluate the information each time a transaction is scored. The raw data can be scored by a model, such as a neural network model. Neural networks are useful tools for interrogating increasing volumes of data and for learning from examples to find patterns in data. By detecting complex nonlinear relationships in data, neural networks can help make accurate predictions about real-world problems. Such a model may use an adaptive segmentation scheme that evolves during the model building process based on the ability of the neural networks to detect changes in transaction attributes.

One of skill in the art will appreciate that various embodiments of the present invention may be implemented using various alternative architectures.

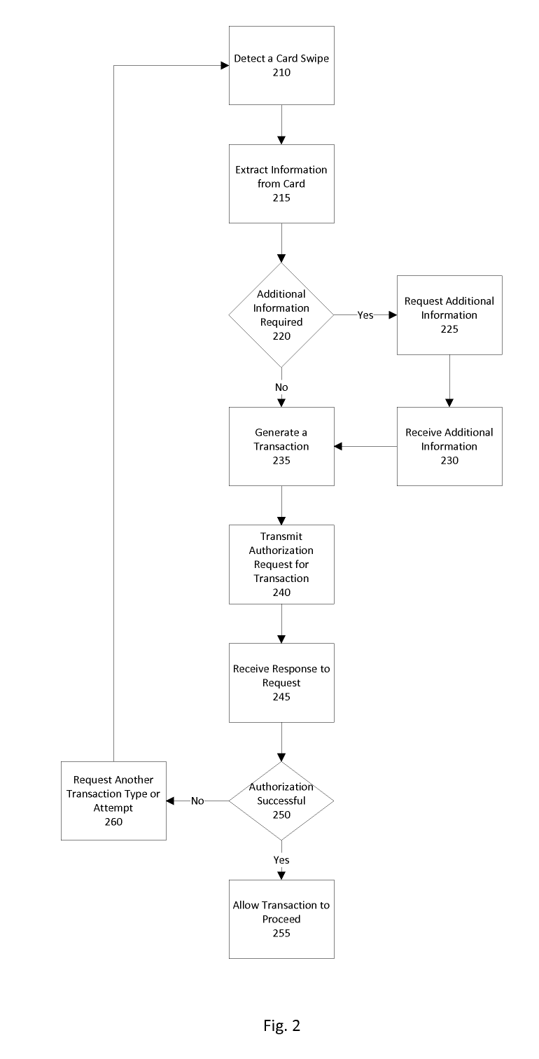

FIG. 2 is a flow chart illustrating an example of a process for accepting a first transaction request from a device, such as client 110. To begin a transaction, client 110 and other types of devices used to perform transactions include card readers, keypads, and/or other devices for accepting input from a user. Such devices may include magnetic readers, short-range radio communication interfaces, such as Bluetooth, optical readers, such as bar code scanners, and the like. Any such device capable of accepting input from the customer, including, for example, reading information from the customer's card or device or otherwise accepting user input, may be utilized in various embodiments. In the embodiment shown, the client 110 includes a card reader and begins the process by detecting a card swipe in operation 210 using a magnetic card reader.

The processor in the client 110 receives an information record from the card reader and extracts the relevant information from the data in operation 215. For example, the processor may extract the name, ATM card number, and expiration date from the data provided by the reader.

The client 110 next determines whether additional information is required in operation 220. If such information is required, the client 110 requests the additional information in operation 225. For example, for a payment transaction, the client 110 may request that the user enter the amount of money to be transferred along with the accounts from which the money is to be transferred and the payee associated with the payment. For an ATM card, the client 110 may also request that the user enter a personal identification number (“PIN”). The client 110 then receives the information in operation 230.

In the embodiment shown in FIG. 2, once the client 110 has the information to create a transaction, the client 110 generates a transaction in operation 235. The transaction includes data. For example, the transaction may include a timestamp, identify the two parties, payer and payee, associated with the transaction, the card information for the card used to generate the transaction, and the payment amount.

The client 110 then transmits an authorization request for the transaction to the transaction processing system 130 over the network 120. In some embodiments, the network 120 may include the internet. While the network 120 is illustrated by a link between the client 110 and the network 120, the network 120 likely includes several different entities. This flow is meant to be illustrative and other data flows and architectures may be utilized by various embodiments. In addition to the information provided by the user, the client 110 may include additional information. For example, a date, and time may be added to the customer's information as part of the transaction. Once the transmission has been sent, the client 110 waits for a response.

In the embodiment shown in FIG. 2, the client 110 next receives a response to the request 245. The response will indicate whether the authorization of the payment was successful 250. If the request is successful, the client 110 will allow the transaction to proceed in operation 255. For example, the money will be transferred from the customer to the payee. If the transaction is not successful, the client 110 requests another transaction type or attempts with the same card in operation 260. The transaction may fail for any number of reasons such as exceeding an account balance or because the PIN does not match information stored in the data store 150 for that particular card. The data store 150 may include raw data. In some embodiments, raw data may not be summarized. By storing raw data, the data store 150 may be able to make comparisons among the data that would be difficult with summarized data.

Once the transaction has been approved to proceed, the customer completes the transaction. For example, in the embodiment shown, once the customer receives confirmation that the transaction has been successfully performed, the customer can receive a receipt that shows the amount of the transaction and the resulting balance of the two accounts from which the payment was made.

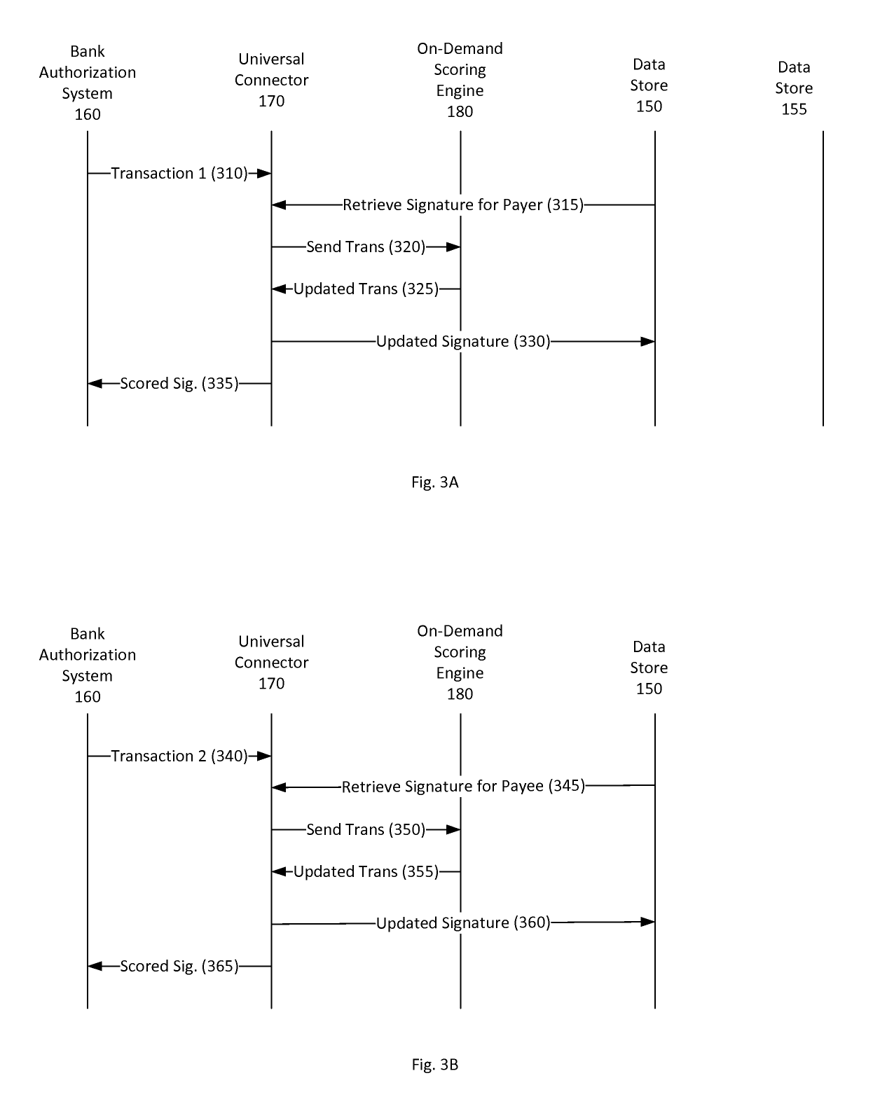

FIGS. 3A and 3B show timing diagrams illustrating an example of the process of a transaction in an example system using signatures. In some systems, a data store, such as data store 150, may maintain a history of all transactions on a credit card account. Alternatively, data store 150 may include a history of all outbound funds transfers from a single account. In the case of a funds transfer between accounts, when a transfer is described in a single transaction, this example system may not be implemented in a manner to keep track of the outbound funds for the sending account and the inbound funds on the receiving account at the same time. It could be described if the client sent in the transaction twice, one as an outbound funds transfer for the sender and one for an inbound deposit for the receiver. In order to represent the complete funds transfer, the bank may have to process two transactions as illustrated in FIGS. 3A and 3B for this example system.

FIG. 3A is a timing diagram illustrating an example of the processing of a transfer from a payer account. First, a customer goes online and performs a transfer of $1000 from payer account to a payee account as described in relation to FIG. 2, for example. The bank's account management system 160 formats a transaction for the payer account representing $1000 being transferred out of the account. This transaction is then sent to a financial management system that includes the UC (170) 310. The UC 170 then retrieves the signature for the payer account 315 from the account signature data store 150.

Next, the UC 170 transmits the transaction information and the signature data to the OSE 180 for processing 320. The OSE 180 updates the payer's signature with the details regarding this $1000 debit to the account. The OSE 180 also uses the model to score the updated signature information and places the score on the transaction. The score may indicate a likelihood of one or more factors including a likelihood of fraud, a likelihood of credit risk, a likelihood of attrition, or a likelihood of commercial interest.

The OSE 180 then sends the updated signatures and transaction information to the UC (170) 325. The UC 170 then saves the updated information 330 to the payer signature database 150 and transmits the scored transaction to the account management system 160 at the bank 335.

FIG. 3B is a timing diagram illustrating an example of the processing of a transfer to a payee account. As described above, the bank first formats a transaction for the payee account representing $1000 being deposited. The bank's account management system 160 formats a transaction for the payee account representing $1000 being deposited into the account. This transaction is then sent to a financial management system that includes the UC (170) 340. The UC 170 then retrieves the signature for the payee account 345 from the account signature data store 150.

Next, the UC 170 transmits the transaction information and the signature data to the OSE 180 for processing 350. The OSE 180 updates the payee's signature with the details regarding this $1000 credit to the account. The OSE 180 also uses the model to score the updated signature information and places the score on the transaction.

The OSE 180 then sends the updated signatures and transaction information to the UC (170) 355. The UC 170 then saves the updated information 360 to the payee signature database 150 and transmits the scored transaction to the account management system 160 at the bank 365.

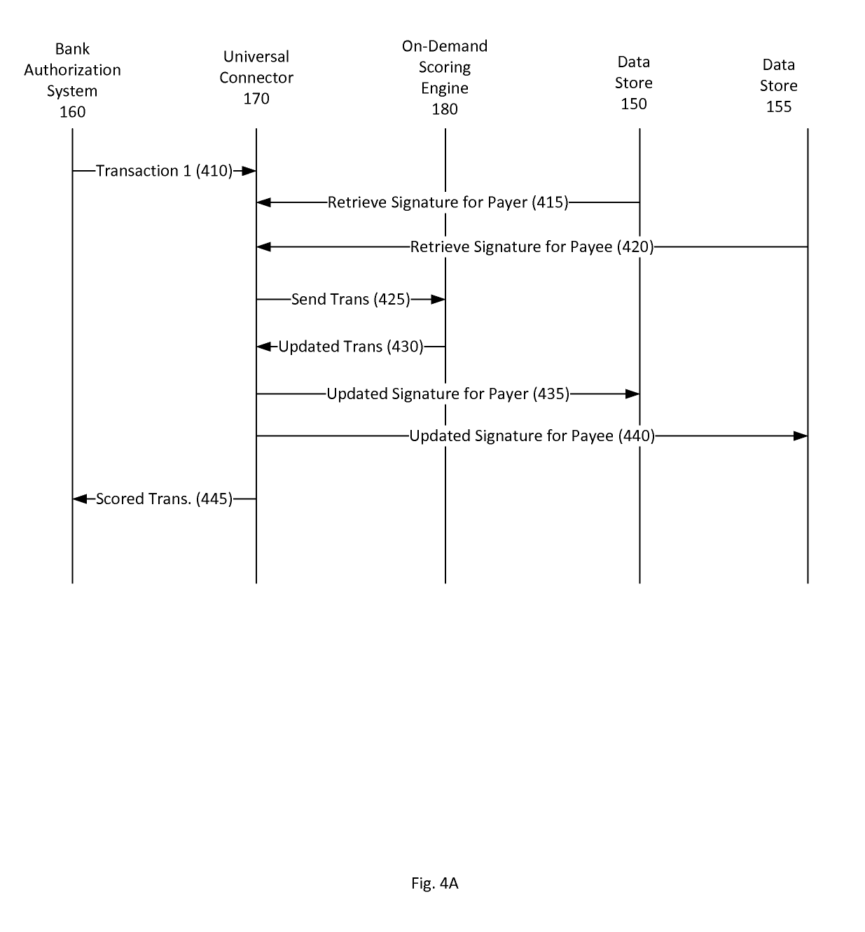

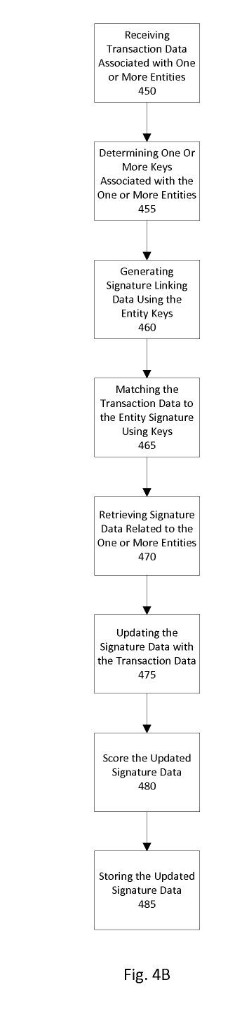

In some embodiments, the bank may only need to transmit a single transaction rather than two transactions, thus saving the bank processing time and disk space. In previous art, this would not be possible when using signatures describing an account, as it would not be possible to access the same data store and retrieve the information for two signatures of the same type. However, using the current invention, then in such an embodiment, the payer and payee signatures are symbolically linked. In other words, if the transaction requires multiple entities of the same type and therefore in the same signature database, one, e.g., data store 155, can just be a pointer to another, e.g., data store 150, without incurring namespace collisions. The information that is used to link the two signatures together may be referred to as signature linking data. In conventional systems if a process retrieves the payer's and payee's signature at the same time, a namespace collision occurs because all elements on the signature for the payer account and all elements on the signature for payee account would have the same name. The timing diagram in FIGS. 4A and 4B below describes the same transaction as depicted in FIGS. 3A and 3B using such a process.

FIG. 4A is a timing diagram illustrating an example of the processing of a transfer from a payer account to a payee account utilizing symbolically linked signatures. First, a customer goes online and performs a transfer of $1000 from payer account to a payee account as described in relation to FIG. 2. The bank's account management system 160 formats a transaction for the payer account representing $1000 being transferred out of the payer account and into the payee account. This transaction is then sent to a financial management system that includes the UC (170) 410. The UC 170 then retrieves the signature for the payer account 415 from the account signature data store 150. The UC 170 also retrieves the signature for the payee account 420 from the account signature data store 155, which is a link to data store 150.

Next, the UC 170 transmits the transaction information and the signature data to the OSE 180 for processing 425. The OSE 180 updates the payer's signature with the details regarding this $1000 debit to the account and updates the payee's signature with the details regarding this $1000 credit to the account. The OSE 180 also uses the model to score the updated signature information for both the payer and payee and places the score on the transaction.

The OSE 180 then sends the updated signatures and transaction information to the UC (170) 430. The UC 170 then saves the updated payer information 435 to the account signature database 150 and the updated payee information 440 to the account signature database 155. Finally, the UC 170 transmits the scored transaction to the account management system 160 at the bank 445.

In addition to saving processing time and space, such a process allows for more accurate scoring for the payer and payee. The transaction shown in FIGS. 3 and 4 may be only a single transaction, so only a single score should be produced for the transaction in order to assess its risk. By implementing symbolic links, while it appears that multiple signature databases are used to provide data regarding a transaction, only a single database is used. For example, while data store 150 and data store 155 are illustrated as two separate databases, in embodiments of the present invention, they can be implemented as a single signature database containing all of the account signatures. As new entities are encountered, i.e., a first transaction is submitted for an entity, the signature database grows. However, in some embodiments, each time a new transaction occurs that includes only one new entity, only a single new signature is created in the signature database.

FIG. 4B is a flowchart illustrating an example of processing of a transfer from a payer account to a payee account utilizing symbolically linked signatures. First, a customer goes online and performs a transfer of $1000 from payer account to a payee account as described in relation to FIG. 2. The bank's bank authorization system 160 formats a transaction for the payer account representing $1000 being transferred out of the payer account and into the payee account. This transaction data, which is associated with one or more entities, such as the payer and payee, is then sent to a financial management system that includes the UC 170. The UC 170 receives the transaction data associated with the one or more entities 450. The transaction data is also associated with one or more keys.

The UC 170 provides the data to the OSE 180, which determines one or more keys associated with the one or more entities 455. The scoring engine may be used to dynamically determine the one or more keys associated with the transaction data and whether one or more entities are associated with the signature data. Each of the entities has corresponding signature data, and the signature data is also associated with one or more keys. The signature data may include historical data associated with an entity. The entity may be associated with a type, such as personal or business.

The OSE 180 may then generate signature linking data as described above using the entity keys 460. The OSE 180 next matches transaction data to the signature data using the keys, which are associated with each.

The OSE 180 then retrieves the signature data corresponding to or related to the one or more entities 470. The OSE 180 then updates the signature data with the transaction data 475. The OSE 180 then uses a scoring engine to score this updated signature data 480. The score may indicate the likelihood of fraud, credit risk, attrition, or of commercial interest. Finally, the UC 170 stores the updated signature data 485.

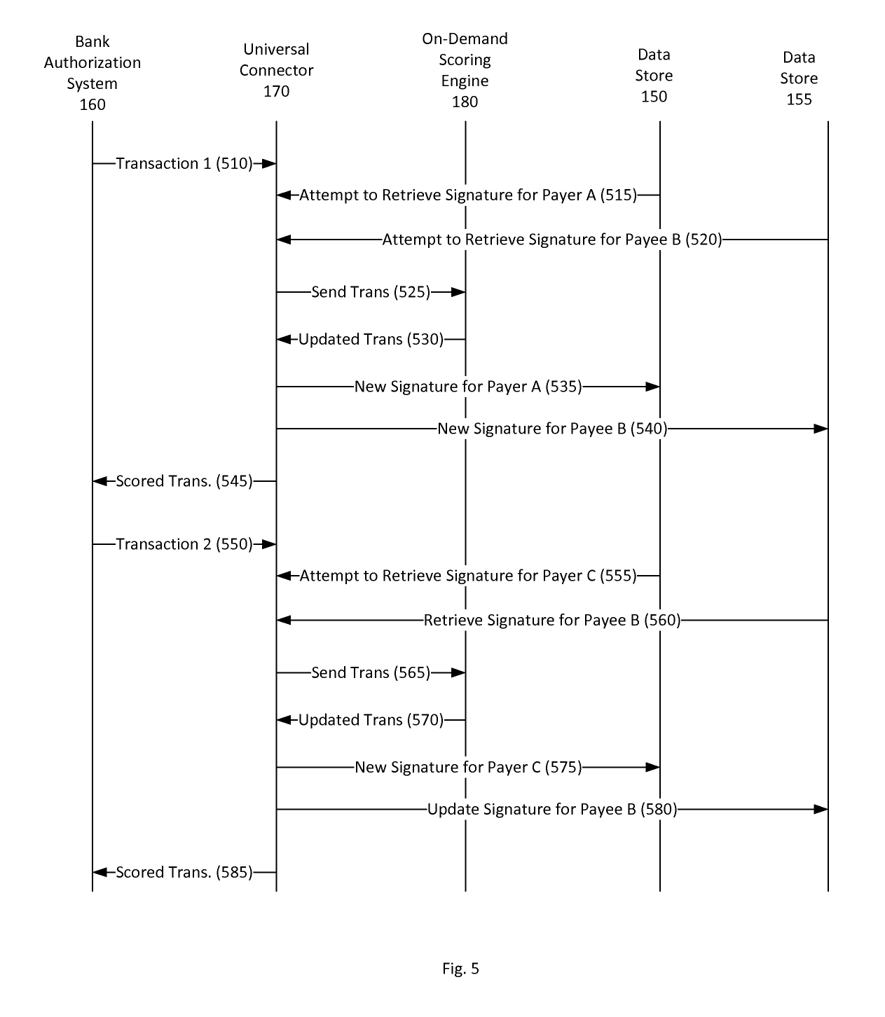

FIG. 5 is a timing diagram illustrating an example of the processing of two transfers from payer accounts to a payee account utilizing symbolically-linked signatures. First, a customer A goes online and performs a transfer of $1000 from payer account A to a payee account B as described in relation to FIG. 2. The bank's account management system 160 formats this transaction for the payer account representing $1000 being transferred. This transaction is then sent to a financial management system that includes the UC (170) 510. The UC 170 then attempts to retrieve the signature for the payer account A 515 from the account signature data store 150. The UC 170 also attempts to retrieve the signature for the payee account B 520 from the account signature data store 155. In some embodiments, these may be a single data store. In the embodiment shown, neither of these attempts to retrieve data is successful since the payer A and payee B have not previously submitted a transaction.

Next, the UC 170 transmits the transaction information and the signature data to the OSE 180 for processing 525. The OSE 180 updates the payer's account A signature with the details regarding this $1000 debit to the account and updates the payee's account B signature with the details regarding this $1000 credit to the account. The OSE 180 also uses the model to score the signatures for both the payer A and payee B.

The OSE 180 then sends the updated signatures and transaction information to the UC (170) 530. The UC 170 then saves the new payer A information 535 to the payer signature database 150 and the updated payee B information 540 to the payee signature database 155. Because the signatures are symbolically linked, this process creates two records in the data store 150. Finally, the UC 170 transmits the scored transaction to the account management system 160 at the bank 545.

Next, a customer C goes online and performs a transfer of $1000 from payer account C to a payee account B as described in relation to FIG. 2. The bank's account management system 160 formats this second transaction for the payer account representing $1000 being transferred. This transaction is then sent to a financial management system that includes the UC (170) 550. The UC 170 then attempts to retrieve the signature for the payer C account 555 from the account signature data store 150. The UC 170 also retrieves the signature for the payee account B 560 from the account signature data store 155. In some embodiments, as stated above, these are a single data store. In the embodiment shown, the attempt to retrieve data for customer C is unsuccessful since the payer C has not previously submitted a transaction.

Next, the UC 170 transmits the transaction information and the signature data to the OSE 180 for processing 565. The OSE 180 updates the payer's account C signature with the details regarding this $1000 debit to the account and updates the payee's account B signature with the details regarding this $1000 credit to the account. The OSE 180 also uses the model to score the signatures for both the payer C and payee B.

The OSE 180 then sends the updated signatures and transaction information to the UC (170) 570. The UC 170 then saves the new payer C information 575 to the payer signature database 150 and the updated payee B information 580 to the payee signature database 155. This process creates another record in the data store 150. Finally, the UC 170 transmits the scored transaction to the account management system 160 at the bank 585. When the two transactions are complete, the data store 150 includes three signatures, one each for A, B, and C.

Various entities described herein can be associated with a signature. The signature may include detailed transaction data for entities such as credit or debit cards, accounts, customers, online banking user-ids, merchants or any other entity of interest. For example, a signature may include a history of all transactions on a credit card account. The history also may include any field maintained in relation to the entity. Some embodiments maintain a history for an entity that cannot be or is not described by a single field on the message. For example, an embodiment may track all transfers between two accounts, Account A and Account B, by maintaining a history of A-B pair. In another example in the credit card arena, an embodiment may track an account's history for a personal card, but an individual card's history for a business card, thus utilizing a single signature database of complex keyed signatures or simply, a complex signature. A complex signature may refer to a signature for two or more entities for which the keys that make up the signature are determined on the fly (e.g., in real time). The complex signature for two or more entities can differ from a simple signature for a single entity. A linked signature, for example, can refer to a first signature that appears to be stored in a data store that is separate from a second signature when, in fact, the first and second signature are stored in the same data store.

Embodiments that support complex keyed signatures can allow a system to track a behavior that is complicated to describe. For example, with ACH transactions, a model may track all transactions between a sender and receiver pair. For instance, an employer pays the same amount into each employee paycheck once or twice per month, and the employer-employee pair can be monitored. If an abnormal amount or frequency of transfers from the employer to a given employee occurs, further investigation may be warranted to ensure someone is not committing fraud, such as stealing money.

Another example in the card fraud arena is different types of credit cards in the United States. For example, with respect to fraud detection, personal credit cards can differ from business credit cards. For a personal credit card, it is difficult to determine which piece of plastic on a given account is making a purchase without examining the data embedded in the magnetic stripe. Therefore, typically account behavior rather than card behavior is observed and a model can be designed to identify fraud at the account level. Further, all cards on the account may need to be reissued even if only one is compromised because they may all have the same card number embossed on the front, for example. However, for business cards in the United States, for example, the employee cards may be embossed with different card numbers while there is a single account number that links them all together. In some situations there may be hundreds or thousands of cards on the same account. When trying to identify fraud on the business accounts, it may be better to monitor behavior at the card level rather than the account level in some situations. Thus, some embodiments may track the spending history on different entities (card level for business cards and account level for personal cards) for different types of accounts.

In one embodiment, a UC 170 makes two calls to the OSE 180. The UC 170 first makes a call to the OSE 180 to request that the OSE 180 resolves what keys should be used as to create the signatures for the particular transaction. The UC 170 then makes a second call to the OSE 180 to determine what keys should be resolved. For example, the OSE 180 may combine the account numbers for accounts A and B into a single string and return that single string as the entity to track. As a second example, the OSE 180 determines whether the transaction is for a personal or a business account. If for a personal account, the OSE 180 returns the account number, and if for a business account, the card number.

Once the OSE 180 determines what keys should be used, the keys are returned to the UC 170. The UC 170 looks up the signature for the entities in the signature database and retrieves the history. The UC 170 then makes a final call to the OSE 180 to execute a model.

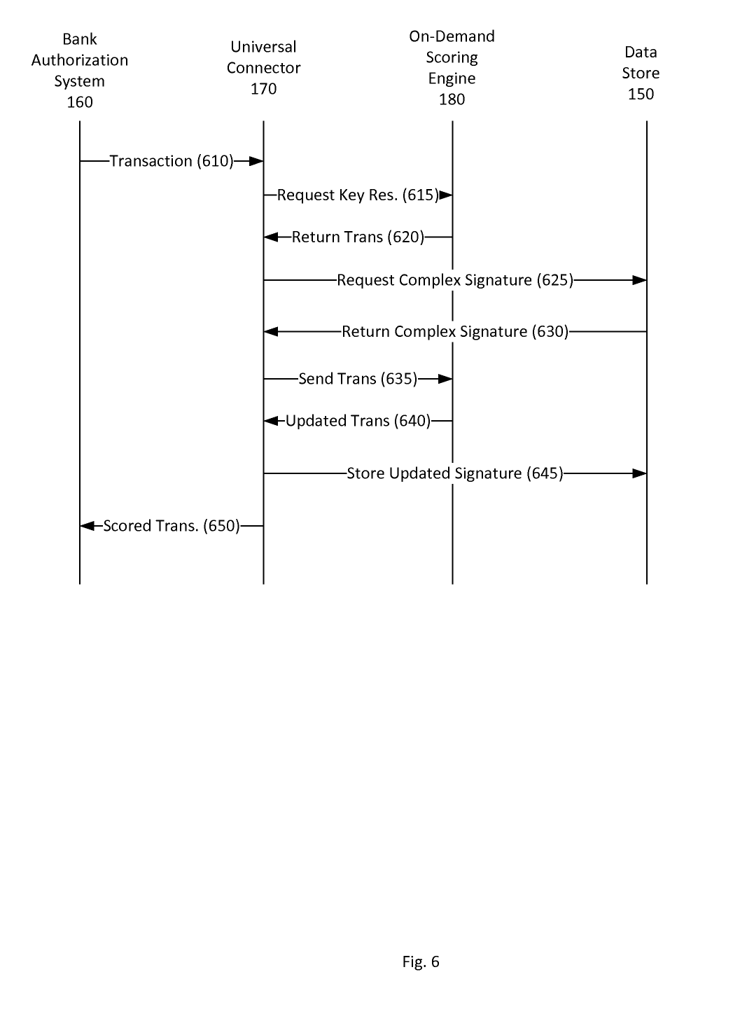

FIG. 6 is a timing diagram illustrating an example process for utilizing complex keyed signatures.

In the embodiment shown, the account management system 160 first receives the transaction data associated with a payer and a payee. This information may include the account numbers for each, a timestamp, and other data associated with a transaction. For example, a customer may wish to transfer $1000 from one of the customer's accounts (Account A) to a payee's account (Account B) as described above. This data then flows to the UC 170.

The UC 170 makes a first call, sending the transaction to the OSE 180 for key resolution 615. The OSE 180 uses a model to resolve which keys should be used to identifier the payer/payee combination for the particular transaction or type of transaction submitted. The process for resolving the keys is dynamic, e.g., the keys to be used are determined on the fly.

The OSE 180 returns the transaction to the UC 170 with the complex key resolved 620. The UC 170 then retrieves the complex key signature from the signature database stored in the signature data store (150) 625.

The UC 170 then makes a second call to the OSE 180, passing the signature-enriched transaction to the OSE 180 for scoring 630. The OSE 180 updates the signature and scores the transaction 635. Then the OSE 180 passes the scored transaction and updated signature back to the UC 170 640.

The UC 170 updates the signature database (data store 150), storing the updated signature 645. Finally, the UC 170 returns the scored transaction to the bank.

Another embodiment may be used in stock trading. In such an embodiment, it may not only be useful to look at the trading activity of stocks themselves, but also the accounts involved, the financial advisors involved, and the offices where those financial advisors work. A complex keyed signature technology can allow the model to keep track of behavior at not just the office, financial advisor, and security level separately, but together as well. The model and rules can identify patterns, such as the number of trades from the same office and financial advisor for the same security in the same day. In these cases, the more of those similar trades across multiple accounts, the more risky the behavior may appear.

In another embodiment, transactions for a single type of establishment can be combined to allow analysis for what a typical transaction would entail. For example, an analyst might wish to identify odd purchases for a franchise, such as Starbucks. The analyst can have all the transactions for similar Starbucks franchises modeled to determine how the typical transaction appears and to identify transactions that do not fit the typical pattern.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus.

The computer readable medium can be a machine readable storage device, a machine readable storage substrate, a memory device, a composition of matter effecting a machine readable communication, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code), can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., on or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of nonvolatile memory, media, and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) to LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any from, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client server relationship to each other.

While this specification contains many specifics, these should not be construed as limitations on the scope of the invention or of what may be claimed, but rather as descriptions of features specific to particular embodiments of the invention. Certain features that are described in this specification in the context or separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

1. A computer implemented method, comprising:
receiving, on a computing device, transaction data associated with one or more entities, wherein the transaction data is associated with one or more keys;
determining, with the computing device, one or more keys associated with the one or more entities, wherein each entity has corresponding signature data, and wherein signature data includes one or more associated keys;
matching the one or more keys associated with the transaction data to one or more keys associated with the signature data corresponding to the one or more entities;
retrieving the signature data corresponding to the one or more entities;
updating the signature data with the transaction data;
using a scoring engine to score the updated signature data; and
storing the updated signature data.

2. The method of claim 1, further comprising:
determining that two or more entities correspond to a same type of entity and are associated with a same transaction;
generating signature linking data using the keys associated with the two or more entities;
retrieving the signature data corresponding to the two or more entities, using the linking data; and
using the scoring engine to score the updated signature data and the signature linking data, wherein the score utilizes the linking relationship between the two or more entities.

3. The method of claim 1, wherein determining one or more key identifiers includes using fields that identify a type of entity and a type of data associated with an entity.

4. The method of claim 1, further comprising:
using the scoring engine to dynamically determine one or more keys associated with the transaction data.

5. The method of claim 1, further comprising:
using the scoring engine to dynamically determine whether one or more entities are associated with the transaction data.

6. The method of claim 1, wherein signature data includes historical data associated with an entity.

7. The method of claim 1, wherein the score indicates a likelihood of one or more factors including a likelihood of fraud, a likelihood of credit risk, a likelihood of attrition, or a likelihood of commercial interest.

8. The method of claim 1, wherein an entity is associated with a type.

9. The method of claim 8, further comprising:
associating account data with an entity when the entity type is personal.

10. The method of claim 8, further comprising:
associating card data with an entity when the entity type is business.

11. The method of claim 1, wherein the signatures corresponding to the one or more entities include simple signatures, complex signatures, and linked signatures.

12. The method of claim 1, wherein matching includes using a scoring engine to dynamically determine one or more keys associated with the one or more entities.

13. The method of claim 1, wherein storing the updated signature data comprises scoring using a neural network.

14. A system, comprising:
one or more processors;
one or more non-transitory computer-readable storage mediums containing instructions configured to cause the one or more processors to perform operations including:
receiving, on a computing device, transaction data associated with one or more entities, wherein the transaction data is associated with one or more keys;
determining one or more keys associated with the one or more entities, wherein each entity has corresponding signature data, and wherein signature data includes one or more associated keys;
matching the one or more keys associated with the transaction data to one or more keys associated with the signature data corresponding to the one or more entities;
retrieving the signature data corresponding to the one or more entities;
updating the signature data with the transaction data;
using a scoring engine to score the updated signature data; and
storing the updated signature data.

15. The system of claim 14, further comprising instructions configured to cause the one or more processors to perform operations including:
determining that two or more entities correspond to a same type of entity and are associated with a same transaction;
generating signature linking data using the keys associated with the two or more entities;
retrieving the signature data corresponding to the two or more entities, using the linking data; and
using the scoring engine to score the updated signature data and the signature linking data, wherein the score utilizes the linking relationship between the two or more entities.

16. The system of claim 14, further comprising instructions configured to cause the one or more processors to perform operations including:
using the scoring engine to dynamically determine one or more keys associated with the transaction data.

17. The system of claim 14, further comprising instructions configured to cause the one or more processors to perform operations including:
using the scoring engine to dynamically determine whether one or more entities are associated with the transaction data.

18. A computer-program product, tangibly embodied in a non-transitory machine-readable storage medium, including instructions configured to cause a data processing system to:
receive, on a computing device, transaction data associated with one or more entities, wherein the transaction data is associated with one or more keys;
determine one or more keys associated with the one or more entities, wherein each entity has corresponding signature data, and wherein signature data includes one or more associated keys;
match the one or more keys associated with the transaction data to one or more keys associated with the signature data corresponding to the one or more entities;
retrieve the signature data corresponding to the one or more entities;
update the signature data with the transaction data;
use a scoring engine to score the updated signature data; and
store the updated signature data.

19. The computer-program product of claim 17, further comprising instructions configured to cause the one or more processors to perform operations including:
determining that two or more entities correspond to a same type of entity and are associated with a same transaction;
generating signature linking data using the keys associated with the two or more entities;
retrieving the signature data corresponding to the two or more entities, using the linking data; and
using the scoring engine to score the updated signature data and the signature linking data, wherein the score utilizes the linking relationship between the two or more entities.

20. The computer-program product of claim 17, further comprising instructions configured to cause the one or more processors to perform operations including:
using the scoring engine to dynamically determine one or more keys associated with the transaction data.

21. The computer-program product of claim 17, further comprising instructions configured to cause the one or more processors to perform operations including:
using the scoring engine to dynamically determine whether one or more entities are associated with the transaction data.
